(19) United States
(12) Patent Application Publication
(10) Pub. No.: US 2017/0052911 A1
(43) Pub. Date: Feb. 23, 2017

(54) MEMORY MODULE HAVING A MEMORY CONTROLLER FOR CONTROLLING NON-VOLATILE MEMORY

(71) Applicant: Lenovo Enterprise Solutions (Singapore) Pte. Ltd., Singapore (SG)

(72) Inventors: William M. Megarity, Raleigh, NC (US); Derek I. Schmidt, Raleigh, NC (US); Zachary B. Durham, Durham, NC (US); Luke D. Remis, Raleigh, NC (US)

(21) Appl. No.: 14/831,039

(22) Filed: Aug. 20, 2015

(51) Int. Cl. G06F 13/16; G06F 13/42; G06F 13/40; G06F 12/02

(52) U.S. Cl. CPC G06F 13/1694; G06F 12/0246; G06F 13/4282; G06F 13/404; G06F 13/4234; G06F 2212/7201

(57) ABSTRACT

A computer memory system comprises non-volatile memory and a memory controller module including a memory controller. The memory controller module is selectively secured in a memory module socket of a motherboard to provide the memory controller in communication with a memory module bus using a memory bus standard. The memory controller includes one or more ports for communication with the non-volatile memory using a data storage protocol, wherein the memory controller controls read and write operations for the non-volatile memory. The memory system further comprises one or more cables connecting the one or more ports of the memory controller to the non-volatile memory, wherein the non-volatile memory is not on the memory controller module. Optionally, the non-volatile memory may be included in a separate memory module or a solid state drive.

### BACKGROUND

Field of the Invention

The present invention relates to computer memory systems using non-volatile memory.

Background of the Related Art

Non-volatile memory is a type of computer memory that retains stored data even after power has been turned off. One example of such non-volatile memory is known as flash memory. NAND type flash memory is commonly used in memory cards, USB flash drives and solid state drives.

A memory card using flash memory may be referred to as “DDR-attached flash” or as a “FlashDIMM.” Such a memory card includes a controller secured to a DIMM-sized module along with the flash memory. The controller is necessary to allow the flash memory to be used in a DIMM socket. Any number of these FlashDIMMs may be used in place of DIMMs that are populated with DRAM.

A solid state drive (SSD) or solid state disk is made with an integrated circuit has no moving parts. Most solid state drives use flash memory that retains stored data even after power has been turned off.

### BRIEF SUMMARY

One embodiment of the present invention provides a memory system comprising non-volatile memory and a memory controller module including a memory controller. The memory controller module is selectively secured in a memory module socket of a motherboard to provide the memory controller in communication with a memory module bus using a memory bus standard. In addition, the memory controller includes one or more ports for communication with the non-volatile memory using a data storage protocol, wherein the memory controller controls read and write operations for the non-volatile memory. The memory system further comprises one or more cables connecting the one or more ports of the memory controller to the non-volatile memory.

Another embodiment of the present invention provides a method comprising providing a memory controller in communication with a memory module bus through a connection between a controller module and a memory module socket on a motherboard, wherein the memory controller is secured to the controller module. The method further comprises the memory controller communicating with a processor on the motherboard over the memory module bus using a memory bus standard, and the memory controller communicating with non-volatile memory over a cable using a data storage protocol.

### BRIEF DESCRIPTION OF THE SEVERAL VIEWS OF THE DRAWINGS

FIG. 1 is a plan view of a motherboard.

FIG. 2 is a side view of the motherboard with cables connecting a memory controller module to two non-volatile memory modules.

FIG. 3 is a plan view of the memory controller module.

FIG. 4 is a plan view of one of the non-volatile memory modules.

FIG. 5 is a plan view of a memory controller module.

FIG. 6 is a schematic view of the memory controller module in communication with a processor via a memory module bus using a memory bus standard and in communication with multiple solid state drives using a data storage protocol.

FIG. 7 is a flowchart of a method according to one embodiment of the present invention.

### DETAILED DESCRIPTION

One embodiment of the present invention provides a memory system comprising non-volatile memory and a memory controller module including a memory controller. The memory controller module is selectively secured in a memory module socket of a motherboard to provide the memory controller in communication with a memory module bus using a memory bus standard. In addition, the memory controller includes one or more ports for communication with the non-volatile memory using a data storage protocol, wherein the memory controller controls read and write operations for the non-volatile memory. The memory system further comprises one or more cables connecting the one or more ports of the memory controller to the non-volatile memory.

The memory controller module may include a plurality of connectors, such that each connector is coupled to one of the ports from the memory controller and is configured to be selectively coupled to one of the cables. Alternatively, the cables may be fixedly connected to the ports of the memory controller. Similarly, each non-volatile memory module may have a connector for selectively coupling to a connector on one of the cables.

Optionally, the memory controller may be referred to as a converter chip, since the memory controller is responsible for communicating with the memory bus on the motherboard using a memory bus standard and also responsible for communicating with the non-volatile memory using a data storage protocol. Accordingly, the memory controller may be considered as “converting” one memory bus standard to another. This conversion must occur in two directions, since read and write operations in the memory bus standard will cause read and write operations in the data storage protocol. Without limitation, the memory controller may be a “DDR to SAS converter chip” or a “DDR to SATA converter chip.”

In another embodiment of the memory system, the non-volatile memory is included in a non-volatile memory module received in a second memory module socket on the motherboard. Accordingly, the memory controller module and the non-volatile memory module may both be installed in memory module sockets of a motherboard. Both the memory controller module and the non-volatile memory module may be provided with electrical power through engagement with a memory module socket. However, the memory controller module communicates with the memory module bus and the non-volatile memory is only in communication with the memory controller and not the memory module bus. In one option, the memory bus standard is DDR (double data rate) and the data storage protocol is SATA (serial ATA). Still further, the non-volatile memory may include a plurality of non-volatile memory modules, wherein each non-volatile memory module is selectively secured in a separate memory module socket of the motherboard. In fact, the memory controller module may be installed in a DIMM slot and have at least 10 SATA ports without saturating the DDR bus, since the DDR bus has a transfer rate upwards of 120 Gb/s while a single SATA port can only consume about 12 Gb/s.

The non-volatile memory may be flash memory. Furthermore, a non-volatile memory module may include a plurality of non-volatile memory devices, such as a plurality of flash memory devices. Even the memory controller module may have non-volatile memory, such as a plurality of non-volatile memory devices. However, the memory controller consumes power and surface area of the module's printed circuit board, such that there is less power and surface area available for memory devices. Conversely, the non-volatile memory modules are coupled to the memory controller via cables, such that the non-volatile memory modules do not need their own controller. Therefore, the non-volatile memory modules may dedicate more power and more surface area to non-volatile memory devices than the memory controller module. It is also beneficial that having one memory controller for multiple non-volatile memory modules produces less heat than if each memory module had its own memory controller.

In yet another embodiment of the memory system, the non-volatile memory may be included in a solid state drive (or “NVMe drive”), such as a drive made with flash memory. Optionally, a solid state drive may still have a common hard disk drive form factor, such as a 2.5″ HDD form factor. In one non-limiting example, the memory bus standard may be DDR and the data storage protocol may be SAS. Optionally, the non-volatile memory may be included in multiple solid state drives. In a further option, the memory controller may distribute data across the multiple solid state drives to form a redundant array of independent disks (RAID).

Embodiments of the present invention may provide the controller module and the non-volatile memory module in a common form factor to be received and secured in memory module sockets on the motherboard. One preferred form factor is the dual in-line memory module (DIMM). Advantageously, the controller module and the non-volatile memory module may be received in the memory module sockets without modification of the sockets or any aspect of the motherboard. While the controller module will have all DIMM pins connected and enabled, it is only necessary for the non-volatile memory module to connect with the socket power and ground pins.

Another embodiment of the present invention provides a method comprising providing a memory controller in communication with a memory module bus through a connection between a controller module and a memory module socket on a motherboard, wherein the memory controller is secured to the controller module. The method further comprises the memory controller communicating with a processor on the motherboard over the memory module bus using a memory bus standard, and the memory controller communicating with non-volatile memory over a cable using a data storage protocol. It should be recognized that various aspects of the foregoing method may be implemented in computer readable program instructions.

In one embodiment of the method, the non-volatile memory may be included in a non-volatile memory module received in a memory module socket on the motherboard. Accordingly, the memory bus standard is suitable for the memory bus on the motherboard, such as a DDR standard, and the data storage protocol is suitable for the non-volatile memory, such as a SATA standard. The method may further include providing the non-volatile memory with electrical power through a connection between the non-volatile memory module and the memory module socket.

In a further embodiment of the method, the non-volatile memory module may include a plurality of non-volatile memory devices, and the controller module may include one or more non-volatile memory devices. Optionally, the memory controller may control write operations so that the non-volatile memory devices on the non-volatile memory module will have a higher wear rate than the non-volatile memory devices on the single controller module. This may be beneficial so that the more-expensive controller module does not need to be replaced due to wear as soon as the non-volatile memory module.

In yet another embodiment of the method, the non-volatile memory is included in a solid state drive. In example, the memory bus standard is DDR and the data storage protocol is SAS (serial attached SCSI or serial attached small computer system interface). The non-volatile memory may be included in multiple solid state drives, such that the memory controller may distribute data across the multiple solid state drives to form a redundant array of independent disks.

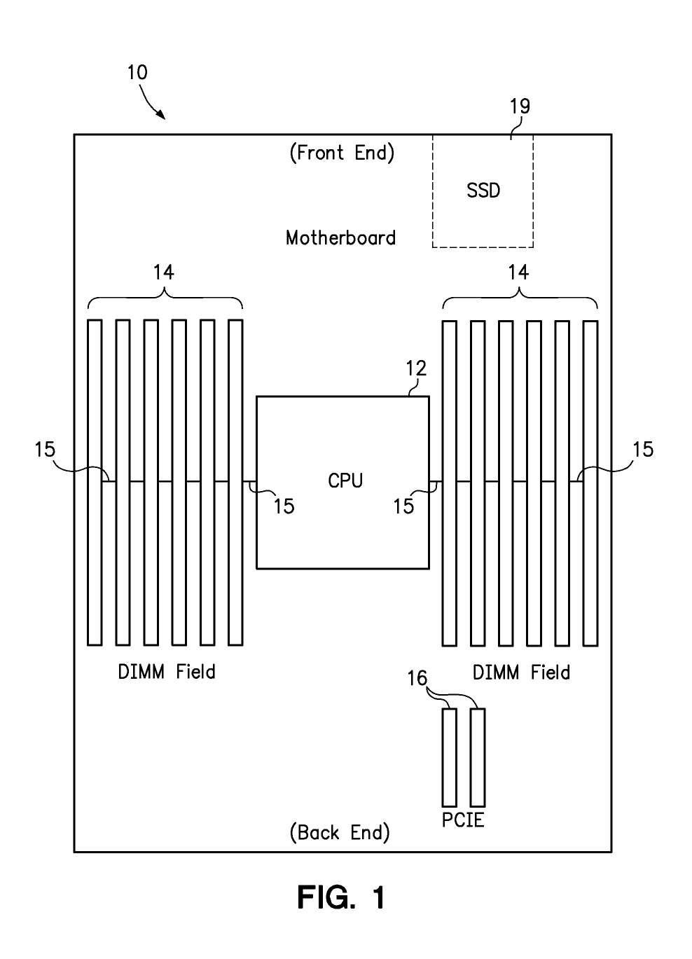

FIG. 1 is a plan view of a motherboard 10 as might be installed in a compute node, network switch, or network-attached storage device. The motherboard 10 shows only certain components or elements to facilitate a discussion of the present invention. Other components and other arrangements may be implemented consistent with the scope of the invention.

The motherboard 10 includes a processor (“CPU”) 12 in communication with memory module sockets 14 via a memory module bus 15. As shown in this non-limiting example, the memory module sockets 14 have a form factor for securing DIMMs and are arranged into a “DIMM Field” of six sockets on each side of the processor.

The motherboard 10 further includes optional PCIe (peripheral component interconnect express) sockets 16. These sockets 16, 18 are shown for context only, and are not required by embodiments of the present invention. Consistent with certain embodiments of the present invention, a solid state drive is shown in a position along a front end of the motherboard 10, although the solid state drive 19 is typically received in a chassis bay rather than being secured to the motherboard 10.

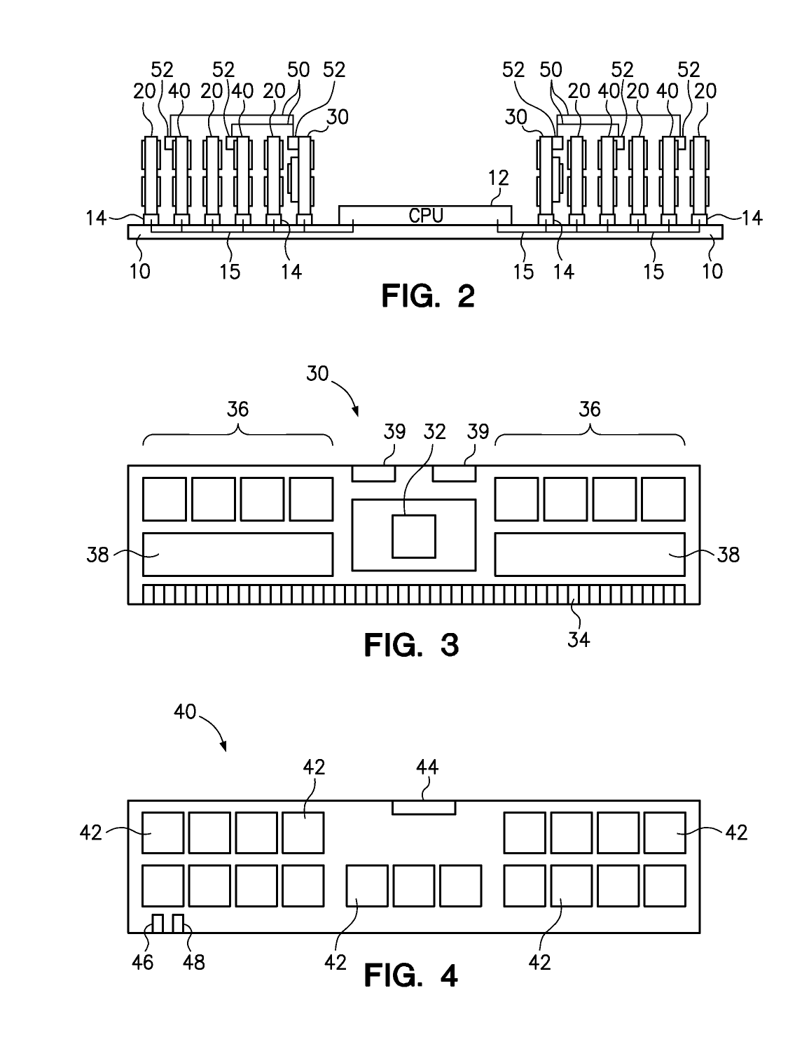

FIG. 2 is a side view of the motherboard 10. The CPU 12 is mounted to the motherboard 10 between the two sets of six DIMM sockets 14. Accordingly, the CPU 12 can communication with modules received in the DIMM sockets 14 via a memory module bus 15 form on or in the motherboard 10. As shown, the DIMM sockets 14 are fully populated with modules having a DIMM form factor. Some of the modules may be DIMM 20 having volatile DRAM (dynamic random access memory) chips. However, the modules also include memory controller modules 30 and non-volatile memory modules 40 in accordance with one embodiment of the present invention. Cables 50 are used to couple a memory controller module 30 to a non-volatile memory module 40. Each cable 50 may have a connector 52 at each end for connecting to a mating connector of either a memory controller module 30 or a non-volatile memory module 40.

It should be recognized that the present invention is not limited to the configuration shown. The invention does not require the presence of any DRAM, and may include the use of greater or lesser numbers of memory controller modules 30, non-volatile memory modules 40, and cables 50. In the non-limiting embodiment shown in FIG. 2, there is one memory controller module 30 on each side of the CPU 12, and two non-volatile memory modules 40 on each side of the CPU 12 coupled via cables 50 to the memory controller module 30 that is on the same side as the non-volatile memory modules.

FIG. 3 is a plan view of the memory controller module 30. The memory controller module 30 includes a memory controller 32 (i.e., a DDR to SATA converter) coupled to an array of edge contacts 34 arranged in a pinout defined by a memory bus standard (i.e., DDR) in order to facilitate communication with a processor (12) via the memory module socket (14) and memory module bus (15) shown in FIGS. 1 and 2. The memory controller 32 is also in communication with an onboard array of eight non-volatile memory devices 36, such as flash memory devices, for the purpose of reading and writing operations. Power and buffer circuitry 38 may also be included. Still further, the memory controller 32 is in communication with any number of connectors 39 (only two shown) to which a cable (50) may be connected as shown in FIG. 2.

FIG. 4 is a plan view of one of the non-volatile memory modules 40. The non-volatile memory module 40 includes an array of nineteen non-volatile memory devices 42 coupled to a connector 44 that is designed to mate with a cable connector (52) as shown in FIG. 2. The non-volatile memory module 40 also includes a power contact 46 and a ground contact 48, or any number of power and ground contacts 46, 48, to obtain electrical power from a memory module socket. Since the non-volatile memory module 40 do not communicate through the memory module socket on the motherboard, the pinout only needs to include power and ground contacts.

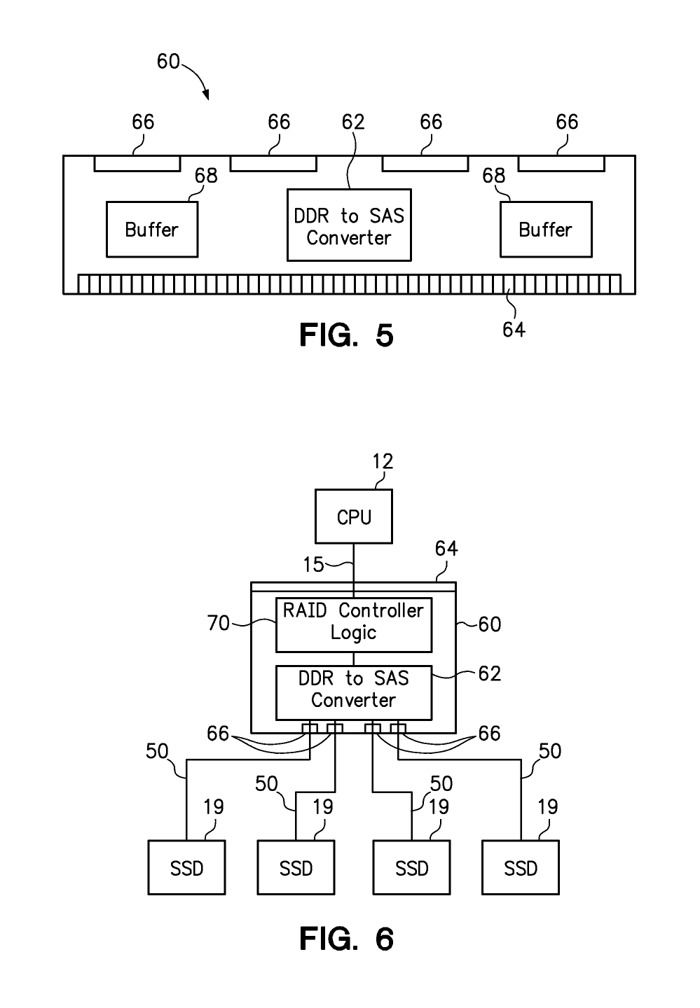

FIG. 5 is a plan view of a simplified memory controller module 60 that may be used, for example, to controlling any number of solid state drives (SSDs). The memory controller 62 (i.e., a DDR to SAS converter) is coupled to an array of edge contacts 64 arranged in a pinout defined by a memory bus standard (i.e., DDR) in order to facilitate communication with a processor (12) via the memory module socket (14) and memory module bus (15) shown in FIGS. 1 and 2. The memory controller 62 is also coupled to four connectors 66 configured to connect with a cable (50) as shown in FIG. 2. Accordingly, the memory controller module 60 may control up to four solid state drives (19) as shown in FIG. 1. In this example, the memory controller module 60 has a DIMM form factor and includes a pair of buffers.

FIG. 6 is a schematic view of the memory controller module 60 of FIG. 5 in communication with a processor 12 via a memory module bus 15 using a memory bus standard (i.e., DDR) and in communication with multiple solid state drives 19 via separate cables 50 using a data storage protocol (i.e., SAS or SATA). The array of edge contacts 64 connect the memory controller module 60 to the memory module bus 15, and the four connectors 66 connect to the individual cables 50 that extend to the solid state drives 19. In addition to the memory controller 62 (labeled here as a “DDR to SAS Converter”), the memory controller module 60 may include optional RAID controller logic 70. In embodiments where RAID capabilities are desired, the RAID capabilities may be included either within the memory controller chip or within another chip on the same DIMM-sized board.

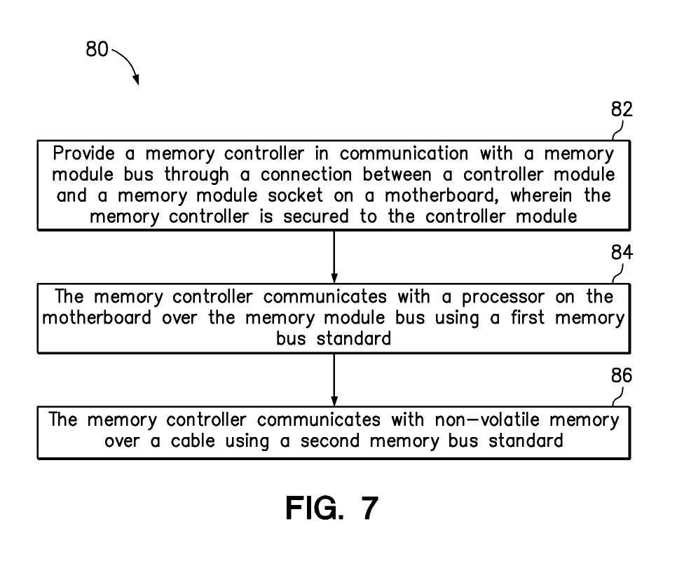

FIG. 7 is a flowchart of a method 80 according to one embodiment of the present invention. In step 82, the method provides a memory controller in communication with a memory module bus through a connection between a controller module and a memory module socket on a motherboard, wherein the memory controller is secured to the controller module. In step 84, the memory controller communicates with a processor on the motherboard over the memory module bus using a memory bus standard. In step 86, the memory controller communicates with non-volatile memory over a cable using a data storage protocol.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A memory system, comprising:
non-volatile memory;
a memory controller module including a memory controller, wherein the memory controller module is selectively secured in a memory module socket of a motherboard to provide the memory controller in communication with a memory module bus using a memory bus standard, and wherein the memory controller includes one or more ports for communication with the non-volatile memory using a data storage protocol; and
one or more cables connecting the one or more ports of the memory controller to the non-volatile memory, wherein the memory controller controls read and write operations for the non-volatile memory.

2. The memory system of claim 1, wherein the non-volatile memory is included in a non-volatile memory module received in a second memory module socket on the motherboard.

3. The memory system of claim 2, wherein the memory bus standard is DDR and the data storage protocol is SATA.

4. The memory system of claim 2, further comprising:
providing the non-volatile memory with electrical power through a connection between the non-volatile memory module and the memory module socket.

5. The memory system of claim 2, wherein each non-volatile memory module includes a plurality of non-volatile memory devices.

6. The memory system of claim 5, wherein the plurality of non-volatile memory devices are flash memory devices.

7. The memory system of claim 5, wherein the single controller module includes one or more non-volatile memory devices in communication with the memory controller.

8. The memory system of claim 1, wherein the non-volatile memory includes a plurality of non-volatile memory modules, wherein each non-volatile memory module is selectively secured in a memory module socket of the motherboard.

9. The memory system of claim 2, wherein each non-volatile memory module has a first connector for selectively coupling to a second connector on one of the cables.

10. The memory system of claim 1, wherein the memory controller module includes a plurality of connectors, wherein each connector is coupled to one of the ports from the memory controller, and wherein each connector can be selectively coupled to one of the cables.

11. The memory system of claim 1, wherein the motherboard is installed in a compute node, network switch, or network-attached storage device.

12. The memory system of claim 1, wherein the non-volatile memory is included in a solid state drive.

13. The memory system of claim 12, wherein the non-volatile memory is flash memory.

14. The memory system of claim 12, wherein the memory bus standard is DDR and the data storage protocol is SAS.

15. The memory system of claim 1, wherein the non-volatile memory is included in multiple solid state drives.

16. The memory system of claim 15, wherein the memory controller distributes data across the multiple solid state drives to form a redundant array of independent disks.

17. A method comprising:
providing a memory controller in communication with a memory module bus through a connection between a controller module and a memory module socket on a motherboard, wherein the memory controller is secured to the controller module;
the memory controller communicating with a processor on the motherboard over the memory module bus using a memory bus standard; and
the memory controller communicating with non-volatile memory over a cable using a data storage protocol.

18. The method of claim 17, wherein the non-volatile memory is included in a non-volatile memory module received in a memory module socket on the motherboard.

19. The method of claim 18, wherein the memory bus standard is DDR and the data storage protocol is SATA.

20. The method of claim 18, further comprising:
providing the non-volatile memory with electrical power through a connection between the non-volatile memory module and the memory module socket.

21. The method of claim 17, wherein the non-volatile memory module includes a plurality of non-volatile memory devices, and wherein the single controller module includes one or more non-volatile memory devices, further comprising:
the memory controller controlling write operations so that the non-volatile memory devices on the non-volatile memory module will have a higher wear rate than the non-volatile memory devices on the single controller module.

22. The method of claim 17, wherein the non-volatile memory is included in a solid state drive.

23. The method of claim 22, wherein the memory bus standard is DDR and the data storage protocol is SAS.

24. The method of claim 17, wherein the non-volatile memory is included in multiple solid state drives.

25. The method of claim 24, wherein the memory controller distributes data across the multiple solid state drives to form a redundant array of independent disks.
